(19) United States
(12) Patent Application Publication
(10) Pub. No.: US 2017/0219231 A1
(43) Pub. Date: Aug. 3, 2017

(54) ENERGY EFFICIENT AIR CONDITIONING SYSTEM

(71) Applicant: HON HAI PRECISION INDUSTRY CO., LTD., New Taipei (TW)

(72) Inventor: LAP-SHUN HUI, PASADENA, CA (US)

(73) Assignee: HON HAI PRECISION INDUSTRY CO., LTD., New Taipei (TW)

(21) Appl. No.: 15/420,960

(22) Filed: Jan. 31, 2017

Related U.S. Application Data
(60) Provisional application No. 62/289,357, filed on Feb. 1, 2016.

(51) Int. Cl. F24F 11/00; F04D 25/16; G05B 19/048; F04D 27/00

(52) U.S. Cl. CPC F24F 11/0001; F04D 27/004; F04D 25/166; F04D 27/001; F04D 27/006; F24F 11/0079; F24F 11/0086; G05B 19/048; F24F 2011/0091; G05B 2219/2614

(57) ABSTRACT

An air conditioning system includes a first fan coupled to a first air outlet of a first room, a second fan coupled to a second air outlet of a second room, and a microprocessor controlling a fan speed of the first fan independent of a fan speed of the second fan. The air conditioning system also includes a first control unit and a first sensing unit in the first room, and a second control unit and a second sensing unit in the second room. The microprocessor is configured to adjust the fan speed of the first fan based upon a temperature threshold from the first control unit and a sensed temperature from the first sensing unit. The microprocessor is configured to adjust the fan speed of the second fan based upon a temperature threshold from the second control unit and a sensed temperature from the second sensing unit.

### RELATED APPLICATION(S)

The present application claims the benefit of and priority to a provisional patent application entitled “AIR CONDITIONER,” Ser. No. 62/289,357, filed on Feb. 1, 2016. The disclosure in this provisional application is hereby incorporated fully by reference into the present application.

### TECHNICAL FIELD

The present application generally relates to environmental friendly appliances. More specifically, the present application relates to energy efficient air conditioning systems.

### BACKGROUND

A central air conditioning system distributes conditioned air (e.g., cool or warm) through a network of ducts. Current central air conditioning systems only have one or two control units (e.g., thermostats), where each control unit is responsible for controlling the temperature in multiple rooms in a house. These systems offer little flexibility and provide limited options for users to individually adjust the temperature in each room (e.g., bedrooms, kitchen, living room, and family room) based on their particular needs and preferences.

Also, because the current central air conditioning systems typically have only one air outlet extending from a main duct to each room for delivering cool or warm air from an outdoor condenser/compressor unit, each room may have a different temperature even though the control unit sets a temperature for all of the rooms. For example, the rooms farther away from the outdoor condenser/compressor unit may have a different temperature than the rooms closer to the outdoor condenser/compressor unit. Furthermore, adjusting the temperature in a particular room may require additional energy for delivering more cool or warm air to all of the rooms, which is not energy efficient.

Thus, there is a need in the art for an air conditioning system that can efficiently deliver conditioned air to individual rooms in a house based upon user demand and/or preference.

### SUMMARY

The present disclosure is directed to an energy efficient air conditioning system, substantially as shown in and/or described in connection with at least one of the figures, and as set forth in the claims.

### BRIEF DESCRIPTION OF THE DRAWINGS

FIG. 1A is a schematic block diagram of an air conditioning system according to an exemplary embodiment of the present application.

FIG. 1B is a diagram of an air conditioning system according to an exemplary embodiment of the present application.

FIG. 2 is a schematic block diagram of an application for an air conditioning system according to an exemplary embodiment of the present application.

### DETAILED DESCRIPTION

The following description contains specific information pertaining to implementations in the present disclosure. The drawings in the present application and their accompanying detailed description are directed to merely exemplary embodiments. However, the present application is not limited to merely these exemplary embodiments.

Other variations and embodiments of the present application will occur to those skilled in the art. Unless noted otherwise, like or corresponding elements among the figures may be indicated by like or corresponding reference numerals. Moreover, the drawings and illustrations in the present application are generally not to scale, and are not intended to correspond to actual relative dimensions.

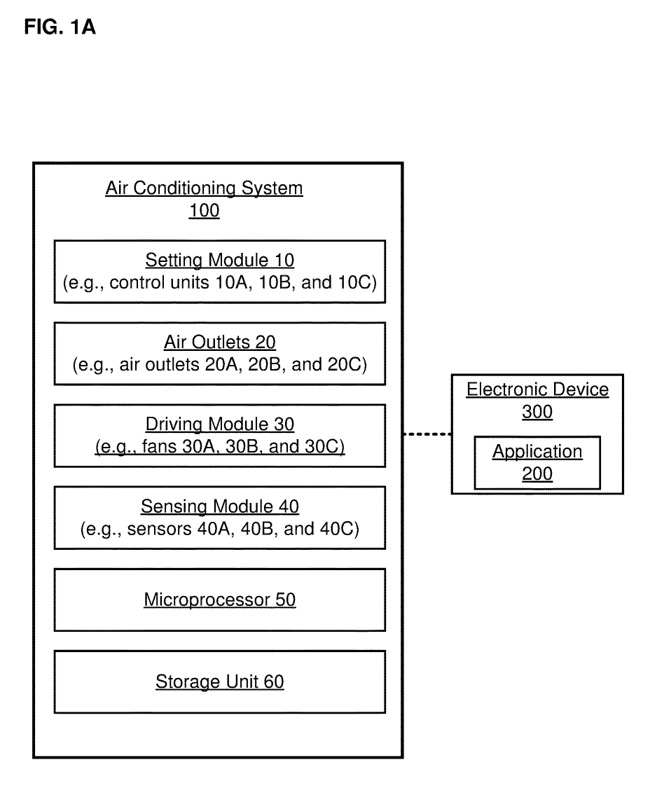

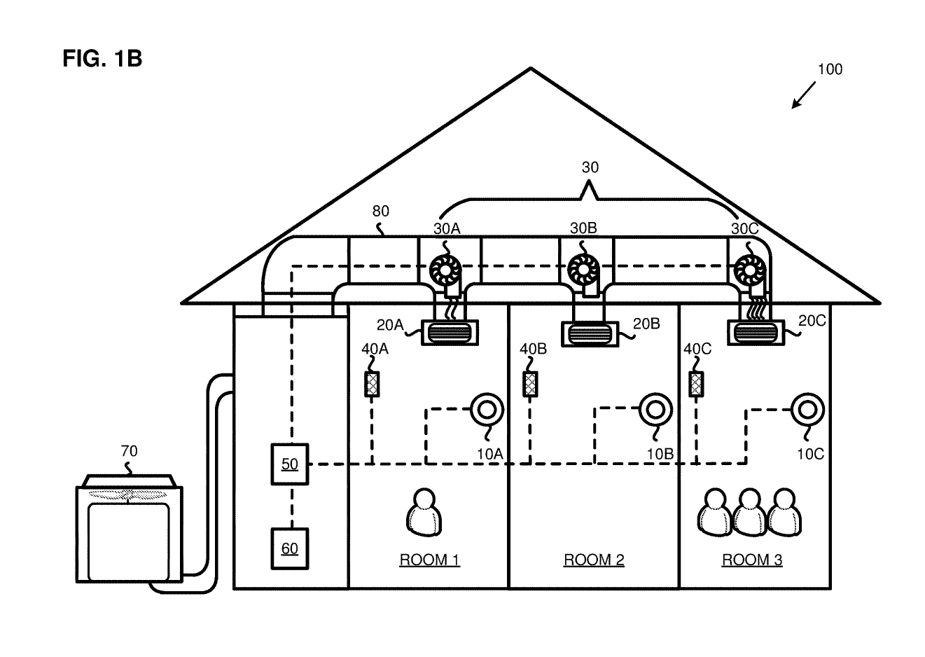

FIG. 1A is a diagram of an air conditioning system according to an exemplary embodiment of the present application. In FIG. 1A, an air conditioning system 100 includes a setting module 10 having control units 10A, 10B and 10C (e.g., thermostats), air outlets 20 having air outlets 20A, 20B, and 20C, a driving module 30 having fans (or motors with turbines) 30A, 30B, and 30C, a sensing module 40 having sensors 40A, 40B, and 40C, at least one microprocessor 50 configured to control the driving module 30, and a storage unit 60. FIG. 1B is a schematic block diagram of an air conditioning system according to an exemplary embodiment of the present application. In the present exemplary embodiment, the air conditioning system 100 may correspond substantially to the air conditioning system 100 in FIG. 1A. The air conditioning system 100 includes the control unit 10A, air outlet 20A, fan 30A, sensor 40A in or near Room 1, the control unit 10B, air outlet 20B, fan 30B, sensor 40B in or near Room 2, the control unit 10C, air outlet 20C, fan 30C, sensor 40C in or near Room 3, the at least one microprocessor 50 configured to control the driving module 30, and the storage unit 60. In FIG. 1B, the air conditioning system 100 also includes an outdoor condenser/compressor unit 70, and a main duct 80.

In at least one exemplary embodiment, the setting module 10 and the sensing module 40 each include computerized instructions in the form of one or more non-transitory computer-readable programs stored in the storage unit 60 (e.g., a computer-readable medium) and capable of being executed by the at least one microprocessor 50 to control the airflow to each of Rooms 1, 2, and 3 by adjusting the speed of each of the fans 30A, 30B, and 30C based upon user demands and/preferences. That is, the functions of the setting module 10 and the sensing module 40 are executed by the at least one microprocessor 50 to control the temperature in each of the rooms individually. In another exemplary embodiment, the setting module 10 and sensing module 40 may respectively provide user input and sensed information (e.g., temperature) to the at least one microprocessor 50, which may execute computerized instructions in the form of one or more non-transitory computer-readable programs stored in the storage device 60 (e.g., a computer-readable medium), to control the airflow to each of Rooms 1, 2, and 3 by adjusting the speed of each of the fans 30A, 30B, and 30C.

It should be noted that FIGS. 1A and 1B merely show examples of the air conditioning system 100, other examples may comprise more or fewer components than those shown in the illustrated embodiment, or have a different configuration of the various components. In at least one exemplary embodiment, the storage unit 60 can be a storage device, such as a random access memory (RAM) for temporary storage of information, and/or a read only memory (ROM) for permanent storage of information. In at least one exemplary embodiment, the storage unit 60 can be an external storage device, such as an external hard disk, a storage card, or a data storage medium.

The setting module 10 includes control units 10A, 10B, and 10C in Rooms 1, 2, and 3, respectively, to individually set a plurality of parameters for each room. In at least one exemplary embodiment, the plurality of parameters includes, but is not limited to, a temperature threshold, a turn-on time, and a turn-off time. For example, the temperature threshold may be a preferred temperature of the user. For example, the control units 10A, 10B, and 10C may be thermostats each having a graphic user interface that allows users to input the plurality of parameters. The control units 10A, 10B, and 10C are coupled to the at least one microprocessor 50 through wired or wireless connections. The at least one microprocessor 50 can execute instructions from the control units 10A, 10B, and 10C, and control the driving module 30 to deliver cool or warm air to each of Rooms 1, 2, and 3 according to different user demands and preferences. For example, the at least one microprocessor 50 may control the fan speed of each of the fans 30A, 30B, and 30C independently. The at least one microprocessor 50 may increase, decrease, or prevent airflow to any of Rooms 1, 2, and 3 by adjusting the fan speed of the corresponding fans 30A, 30B, and 30C, thereby adjusting the temperature of the corresponding Rooms 1, 2, and 3.

In at least one exemplary embodiment, the fans 30A, 30B, and 30C of the driving module 30 are arranged near the air outlets 20A, 20B, and 20C, respectively. For example, the fans 30A, 30B, and 30C are controlled by the at least one microprocessor 50 to direct airflow in different directions and at different speeds, based upon the different user demands and preferences set or entered through the respective control units 10A, 10B, and 10C, and the sensed signals from the sensors 40A, 40B, and 40C, respectively. For example, the fan 30A is configured to direct the airflow from the main duct 80 toward the air outlet 20A in Room 1. The fan 30B is configured to direct the airflow from the main duct 80 toward the air outlet 20B in Room 2. The fan 30C is configured to direct the airflow from the main duct 80 toward the air outlet 20C in Room 3. In another implementation, the air outlet in each room may have multiple fans coupled thereto, where the multiple fans are directed toward different areas of the corresponding room for heating and cooling. For example, in addition to the fan 30A, there are multiple fans coupled to the air outlet 20A in Room 1, where each of the fans is pointed to a different direction of Room 1 for heating and cooling.

Each of the sensors 40A, 40B, and 40C of the sensing module 40 is positioned in a separate room for sensing temperature of that room. For example, the sensors 40A, 40B, and 40C are positioned in Rooms 1, 2, and 3, respectively. The sensors 40A, 40B, and 40C are coupled to the control units 10A, 10B, and 10C, respectively, for example, through wired or wireless connections, to receive the user preferred temperatures for the corresponding rooms. Also, the sensors 40A, 40B, and 40C are each coupled to the at least one microprocessor 50 to provide sensed signals (e.g., sensed temperature) in their corresponding rooms, so that the at least one microprocessor 50 can adjust, among other things, the fan speed of each of the fans 30A, 30B, and 30C. In an exemplary embodiment, at least one of the sensors 40A, 40B, and 40C may include a temperature sensor that can sense temperatures in different areas of the corresponding room.

In at least one exemplary embodiment, the sensors 40A, 40B, and 40C of the sensing module 40 can interface directly to the fans 30A, 30B, and 30C, respectively.

The sensed information from the sensors 40A, 40B, and 40C may be directly provided to the fans 30A, 30B, and 30C, respectively, such that the speed of each of the fans may be adjusted based on the corresponding sensed information. In another exemplary embodiment, the sensors 40A, 40B, and 40C of the sensing module 40 and the fans 30A, 30B, and 30C are coupled to the at least one microprocessor 50, where the at least one microprocessor 50 controls the speeds of the fans 30A, 30B, and 30C based on the sensed information from the sensors 40A, 40B, and 40C, respectively.

In one exemplary embodiment, the preferred temperature can be set for each room through either the control units 10A, 10B, and 10C, or remotely through an application 200 on an electronic device 300, as shown in FIG. 1A. For example, the fan speed of each of the fans 30A, 30B, and 30C may be controlled or adjusted remotely by the application 200 on the electronic device 300.

As shown in FIG. 1B, in the present exemplary embodiment, as Room 3 has the most occupants, Room 3 is likely to need more cool air than Rooms 1 and 2, since Rooms 1 and 2 have fewer occupants than Room 3 does. Thus, based upon a preferred temperature setting input through the control unit 10C in Room 3 (or remotely through the application 200 on the electronic device 300) and the sensed temperature from the sensor 40C, the at least one microprocessor 50 can control the fan 30C to increase the fan speed to deliver more cool air through the air outlet 20C to Room 3 without delivering more cool air to Rooms 1 and 2, thereby saving energy. For example, the at least one microprocessor 50 is configured to adjust the fan speed of fan 30C based upon the temperature threshold entered through the control unit 10C and the sensed temperature of Room 3, in dependent of fans 30A and 30B. In another exemplary embodiment, the sensor 40C can be directly coupled to the fan 30C to change the fan speed based on the sensed temperature in Room 3.

In FIG. 1B, as Room 2 has no occupant in it, Room 2 is likely to need less cool air than Rooms 1 and 3, since Rooms 1 and 3 have more occupants than Room 2 does. Thus, based upon a preferred temperature setting entered through the control unit 10B in Room 2 (or remotely through the application 200 on the electronic device 300) and the sensed temperature from the sensor 40B, the at least one microprocessor 50 can control the fan 30B to reduce the fan speed to deliver less cool air through the air outlet 20B, or completely stop delivering cool air to Room 2, without affecting the airflow to Rooms 1 and 3. For example, the at least one microprocessor 50 is configured to adjust the fan speed of fan 30B based upon the temperature threshold entered through the control unit 10B and the sensed temperature of Room 2, in dependent of fans 30A and 30C. In another exemplary embodiment, the sensor 40B can be directly coupled to the fan 30B to change the fan speed based on the sensed temperature in Room 2.

In FIG. 1B, Room 1 has fewer occupants than Room 3 does, but more occupants than Room 2 does. Thus, Room 1 is likely to need less cool air than Room 3, but more cool air than Room 2. Thus, based upon a preferred temperature setting entered through the control unit 10A in Room 1 (or through the application 200 on the electronic device 300) and the sensed temperature from the sensor 40A, the at least one microprocessor 50 can control speed of the fan 30A to deliver an appropriate amount of cool air to Room 1 without affecting the airflow to Rooms 2 and 3. For example, the at least one microprocessor 50 is configured to adjust the fan speed of fan 30A based upon the temperature threshold entered through the control unit 10A and the sensed temperature of Room 1, in dependent of fans 30B and 30C. In another implementation, the sensor 40A can be directly coupled to the fan 30A to change the fan speed based upon the sensed temperature in Room 1. It should be noted that the fans 30A, 30B, and 30C can each be independently turned on and off, and adjusted to spin faster or slower, to deliver cool/warm air from the outdoor condenser/compressor unit 70 to the respective Rooms 1, 2, and 3, without affecting the other fans.

The preferred temperature in each room can be set through either the corresponding control units 10A, 10B, and 10C or the application 200 in the electronic device 300 as shown in FIG. 1A. If cooling or heating is needed in a particular room, the sensor in the room can signal the corresponding fan to pull more air from the corresponding air outlet. The air conditioning system 100, according to the present exemplary embodiment, can significantly reduce energy consumption as compared to conventional central air conditioning systems, especially when one or more rooms in the house are vacant or occupied by a few occupants. That is, the air conditioning system 100 is configured to adjust the temperature of one of the rooms (e.g., Room 1) without requiring additional energy to adjust the temperature of the other rooms (e.g., Rooms 2 and 3).

In at least one exemplary embodiment, the sensing module 40 can recommend a temperature when there are a number of occupants in the room, which can be manually overridden by the occupants.

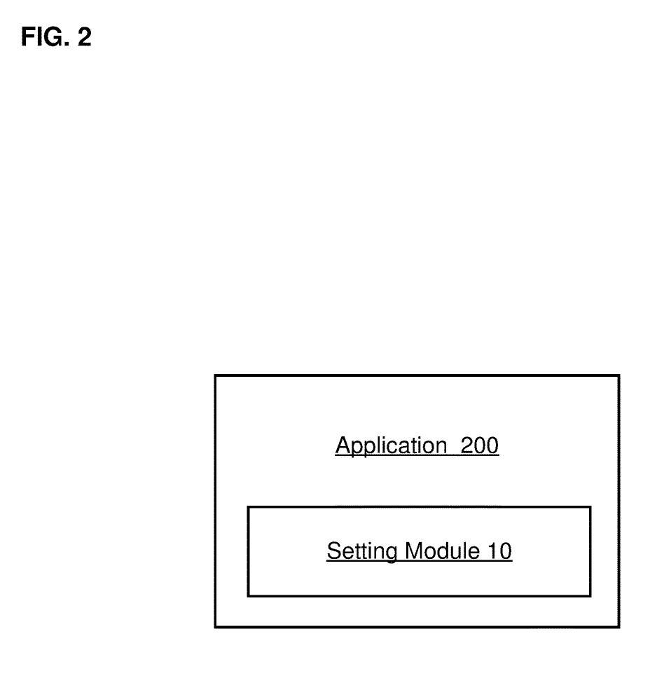

FIG. 2 is a schematic diagram illustrating an application for an air conditioning system in accordance with an exemplary embodiment of the present application. In the present exemplary embodiment, the application 200 in FIG. 2 may correspond to the application 200 in FIG. 1A. As illustrated in FIG. 1A, the application 200 can be stored in the electronic device 300, which is coupled to the air conditioning system 100 through a wireless connection. In at least one exemplary embodiment, when the application 200 is stored in the electronic device 300, the application 200 can display the setting module 10 through a graphic user interface, for example, to allow the user to configure his/her preferences while he/she is in or away from the room.

In operation, the plurality of fans directs the airflows at different directions and speeds. For example, when Room 3 needs more cool air, the fan 30C, controlled by the at least one microprocessor 50, spins faster to pull more cool air to Room 3 through the air outlet 20C. In at least one exemplary embodiment, the fans 30A, 30B, and 30C can be configured to pull air from the outdoor compressor/condenser unit 70, where each of the fans is independent of the other fans, to allow the users to direct and control the temperature of each room without wasting additional energy to cool the other rooms. The sensors 40A, 40B, 40C may include not only temperature sensors, but also identification sensors (e.g., facial and/or voice recognition sensing devices) to detect who is in the room and send signals to the at least one microprocessor 50 to apply the occupant's preferred temperature setting in the room. If there are multiple occupants in the room, the sensing module can recommend a temperature, which can be manually overridden by the occupants. The application 200 can also offer a predetermined hierarchy of occupants. For example, a preferred temperature of occupant A has a higher priority than a preferred temperature of occupant B, or an average preferred temperature of occupant A has a higher priority than a preferred temperature of occupant B.

The exemplary embodiments shown and described above are only examples.

Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

We claim:

1. An air conditioning system comprising:
a first fan coupled to a first air outlet of a first room;
a second fan coupled to a second air outlet of a second room;
a microprocessor controlling a fan speed of the first fan independent of a fan speed of the second fan.

2. The air conditioning system of claim 1 wherein each of the first and second fans is configured to increase, decrease, or prevent an airflow to the corresponding one of the first and second rooms to adjust a temperature therein.

3. The air conditioning system of claim 1 further comprising a first control unit in the first room, and a second control unit in the second room, the first and second control units are coupled to the microprocessor.

4. The air conditioning system of claim 1 further comprising a first sensor in the first room, and a second sensor in the second room, the first and second sensors are coupled to the microprocessor.

5. The air conditioning system of claim 4 wherein the first sensor includes at least one temperature sensor sensing temperatures in different areas of the first room.

6. The air conditioning system of claim 1 wherein the microprocessor is configured to adjust the fan speed of the first fan based upon a temperature threshold and a sensed temperature of the first room.

7. The air conditioning system of claim 1 wherein the microprocessor is configured to adjust the fan speed of the second fan based upon a temperature threshold and a sensed temperature of the second room.

8. The air conditioning system of claim 1 further comprising multiple fans coupled to the first air outlet of the first room, wherein the multiple fans are directed toward different areas of the first room for heating and cooling.

9. The air conditioning system of claim 1 wherein the fan speed of the first fan and the fan speed of the second fan are controlled remotely by an electronic device.

10. The air conditioning system of claim 9 wherein the electronic device includes an application that remotely adjusts a first temperature of the first room or a second temperature of the second room based on a predetermined hierarchy of occupants.

11. An air conditioning system comprising:
a first control unit for controlling a first temperature in a first room;
a first sensor coupled to a first fan for controlling airflow to the first room;
a second control unit for controlling a second temperature in a second room;
a second sensor coupled to a second fan for controlling airflow to the second room;
wherein the air conditioning system is configured to adjust a fan speed of the first fan independent of a fan speed of the second fan.

12. The air conditioning system of claim 11 wherein the first fan is adjacent to a first air outlet of the first room, and the second fan is adjacent to a second air outlet of the second room.

13. The air conditioning system of claim 12 further comprising multiple fans coupled to the first air outlet of the first room, wherein the multiple fans are directed toward different areas of the first room for heating and cooling.

14. The air conditioning system of claim 11 wherein the first sensor includes at least one temperature sensor sensing temperatures in different areas of the first room.

15. The air conditioning system of claim 11 wherein the air conditioning system is configured to adjust the fan speed of the first fan based upon a temperature threshold and a sensed temperature of the first room.

16. The air conditioning system of claim 11 further comprising at least one processor microprocessor for individually controlling the fan speed of the first and second fans.

17. The air conditioning system of claim 11 wherein the first sensor is directly coupled to the first fan to adjust the fan speed of the first fan based upon a sensed temperature from the first sensor.

18. The air conditioning system of claim 11 wherein the first sensor, the first control unit, the second sensor, and the second control unit are coupled to a microprocessor for controlling the fan speed of the first fan and the second fan individually.

19. The air conditioning system of claim 11 wherein the first temperature and the second temperature are adjusted remotely using an electronic device.

20. The air conditioning system of claim 19 wherein the electronic device includes an application that remotely adjusts the first temperature or the second temperature based on a predetermined hierarchy of occupants.
